(19) United States
(12) Patent Application Publication
(10) Pub. No.: US 2009/0295239 A1
(43) Pub. Date: Dec. 3, 2009

(54) HEAT TRANSFER ENHANCEMENT OF VENTILATION CHIMNEYS FOR DYNAMOELECTRIC MACHINE ROTORS

(75) Inventors: Rebecca A. Nold, Scotia, NY (US); Christopher A. Kaminski, Schenectady, NY (US); Emil D. Jarezynski, Scotia, NY (US); Norman J. Suguitan, Ballston Lake, NY (US); Thomas Mancuso, Niskayuna, NY (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/132,172

(22) Filed: Jun. 3, 2008

(51) Int. Cl. H02K 9/02

(52) U.S. Cl. 310/61

(57) ABSTRACT

A cooling gas ventilation chimney is provided for an end region of a dynamoelectric machine having a rotor. A plurality of radial slots are provided in the rotor, and a plurality of coils are seated in the radial slots. The coils form radially stacked turns. The ventilation chimney includes one or more chimney slots that are defined in at least a portion of the radially stacked turns. The chimney slots extend in a substantially radial direction to the rotor, and at least a portion of a surface of the chimney slots is turbulated so as to have a roughened surface profile for enhanced heat transfer.

### BACKGROUND OF THE INVENTION

The present invention relates to increasing heat transfer performance of a ventilation chimney in the rotor of a dynamoelectric machine. Specifically, the invention relates to turbulating the surface of a ventilation chimney in a rotor to increase the heat transfer performance.

The rotors in large gas cooled dynamoelectric machines have a rotor body which is typically made from a machined high-strength solid iron forging. Axially extending radial slots are machined into the outer periphery of the rotor body at specific circumferential locations to accommodate the rotor winding. The rotor winding in this type of machine typically consists of a number of complete coils, each having many field turns of copper conductors. The coils are seated in the radial slots in a concentric pattern with, for example, two such concentric patterns in a two-pole rotor. The coils are supported in the rotor body slots against centrifugal forces by wedges that bear against machined dovetail surfaces in each slot. The regions of the rotor winding coils that extend beyond the ends of the main rotor body are called “end windings” and are supported against centrifugal forces by high strength steel retaining rings. The section of the rotor shaft forging which is disposed underneath the rotor end windings is referred to as the spindle. For ease of reference and explanation herein-below, the rotor winding can be characterized as having a central radial flow region within the radial slots of the rotor body, a rotor end winding region that extends beyond the pole face, radially spaced from the rotor spindle, and a slot end region which contains the radial flow ventilation or discharge chimneys. The slot end region is located between the central radial flow region and the rotor end winding region.

The design of large turbo-electric or dynamoelectric machinery requires high power density in the stator and rotor windings. As ratings increase, both specific loading of the windings (i.e., current carried by a given cross section) and the distance to a heat sink such as a cooler (or heat exchanger) also increase. Additional cooling technology can be employed to carry heat out of the parts of the generator.

Direct cooling of the rotor windings is a well-established practice in electric machinery design. The cooling medium, typically hydrogen gas or air, is introduced directly to the winding in several ways. The gas may enter the rotor through subslots cut radially inside the copper rotor windings. It is exhausted through radial ducts placed in the copper. The pumping action caused by rotation of the rotor and the heating of the gas pulls gas through the subslot and out the radial ducts. Alternatively, gas may be scooped out of the gap at the rotating surface of the rotor and may follow a diagonal or radial-axial path through the copper winding. The gas exhausts once again at the rotor surface without need for a subslot. These two strategies cool the windings in the rotor body.

Rotor end turns may require additional cooling. One established method for this is to place one or more longitudinal grooves in the copper turn. The groove connects to an outlet that will pull gas through the groove. The outlet can be a radially directed duct at the end of the rotor body, or the grooves can lead to a vent slot in the tooth or pole of the rotor body. In general, the retaining ring that mechanically supports the end turns is not penetrated. The end turn grooving strategy can be used with any type of rotor body cooling, either radial or gap-pickup. End turn cooling grooves can also exhaust to a radial ventilation or discharge chimney.

To exhaust the end section gases, the discharge or ventilation chimney is located in the outermost axial position of the rotor body, where it receives no additional cooling from the radial or diagonal flow ducts in the center body section. The discharge chimney is typically the hottest section in the rotor, limiting power output since electrical insulation temperature limits should not be exceeded.

Because of the large number of grooves that typically exhaust to the discharge chimney, the chimney flow cross-section is usually larger than a radial duct used to cool the center body section of the rotor, in both the direction of slot width and along the longitudinal direction of the conductors. Since the cooling gas discharging through the chimney has already cooled and removed heat from the end section, the gas entering the chimney is at elevated temperature. The electrical conductor surrounding the chimney generates heat and also needs to be cooled, and this conductor temperature will be high because it is being cooled with gas at elevated temperature. This causes one of the hottest regions of the rotor to be near the location of the discharge chimney, which limits rotor output and electric power performance. At the same time, the large chimney flow area requires removing more electrical conducting area from the winding, causing increased electrical resistance and heating in the same area where the chimney is cooled with gas at elevated temperature. In addition, the discharge chimney will have less heat transfer surface area on its walls compared to the gas flow cross section in a typical radial cooling duct in the body section of the rotor. Further, because of its large size, the discharge chimney is typically machined such as in a milling operation, and this leaves a smooth surface, and the resulting smooth wall further reduces heat transfer performance.

Accordingly, a need exists in the art for a discharge chimney having improved heat transfer characteristics to more effectively cool the end section of the rotor.

### BRIEF DESCRIPTION OF THE INVENTION

A cooling gas ventilation chimney is provided for an end region of a dynamoelectric machine having a rotor. A plurality of radial slots are provided in the rotor, and a plurality of coils are seated in the radial slots. The coils form radially stacked turns. The ventilation chimney includes one or more chimney slots that are defined in at least a portion of the radially stacked turns. The chimney slots extend in a substantially radial direction to the rotor, and at least a portion of a surface of the chimney slots is turbulated so as to have a roughened surface profile for enhanced heat transfer.

### BRIEF DESCRIPTION OF THE DRAWINGS

FIG. 1 illustrates a schematic of a rotor of a dynamoelectric machine.

FIG. 2 illustrates a sectional view of a ventilation chimney that is located between the end winding region and the central radial flow region of the rotor of FIG. 1.

FIG. 3 illustrates a top-down view, along section line A-A of FIG. 2, and shows the relative size of the ventilation chimney compared to the radial ducts.

FIG. 4 illustrates a view along section line B-B of FIG. 2, and shows a cross section of the termination of the end turn cooling grooves in the ventilation chimney.

FIG. 5 illustrates a sectional view of a turbulated ventilation chimney according to one embodiment of the present invention.

FIG. 6 illustrates a top-down view, along section line A-A of FIG. 5, and shows the relative size of the ventilation chimney compared to the radial ducts.

FIG. 7 illustrates a view along section line B-B of FIG. 5, and shows a cross section of the termination of the end turn cooling grooves in the turbulated ventilation chimney according to one aspect of the present invention.

FIG. 8 illustrates one embodiment of a milling operation that can be used to obtain a turbulated surface for the ventilation chimney.

FIG. 9 illustrates another embodiment of a milling operation that can be used to obtain a turbulated surface for the ventilation chimney.

FIG. 10 illustrates a still further embodiment of a milling operation that can be used to obtain a turbulated surface for the ventilation chimney.

FIG. 11 illustrates a sectional view of a turbulated ventilation chimney according to another embodiment of the present invention.

FIG. 12 illustrates a top-down view, along section line A-A of FIG. 11, and shows the serrations present in the ventilation chimney.

FIG. 13 illustrates a cross sectional view of the termination of the end turn cooling grooves in the ventilation chimney and has an offset flow path according to another embodiment of the present invention.

FIG. 14 illustrates yet another embodiment of the present invention, and shows a cross sectional view of the termination of the end turn cooling grooves in the ventilation chimney having an alternating sized flow path.

### DETAILED DESCRIPTION OF THE INVENTION

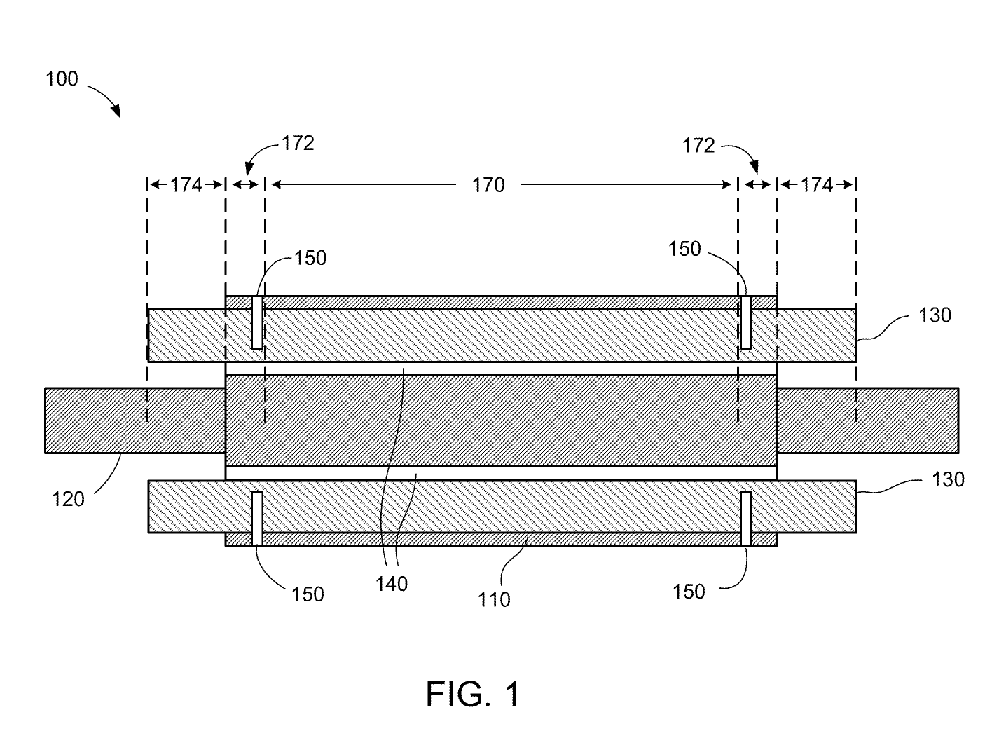

FIG. 1 illustrates a cross-section of a rotor 100 that includes a rotor body 110, rotor spindle 120, winding 130, subslot 140 and ventilation or discharge chimneys 150. Rotor 100 is typically made from a machined high-strength solid iron forging. Axially extending radial slots are machined into the outer periphery of the rotor body 110 at specific circumferential locations to accommodate the rotor winding 130. The rotor winding 130 typically comprises a number of complete coils, each having many field turns of copper conductors. The coils are seated in the radial slots in a concentric pattern with, for example, two such concentric patterns in a two-pole rotor. The coils are supported in the rotor body slots against centrifugal forces by wedges that bear against machined dovetail surfaces in each slot. The regions of the rotor winding coils that extend beyond the ends of the main rotor body are called “end windings” and are supported against centrifugal forces by high strength steel retaining rings. The end winding section is illustrated by region 174. The section of the rotor shaft forging which is disposed underneath the rotor end windings is referred to as the spindle 120. For ease of reference and explanation herein-below, the rotor winding can be characterized as having a central radial flow region or body cooling region 170 within the radial slots of the rotor body. The end winding region 174 extends beyond the pole face, and is radially spaced from the rotor spindle. The slot end region 172 contains the discharge chimneys 150. The slot end region 172 is located between the body cooling region 170 and the end winding region 174. In some embodiments, the rotor end region can include the slot end region 172 and/or the end winding region 174.

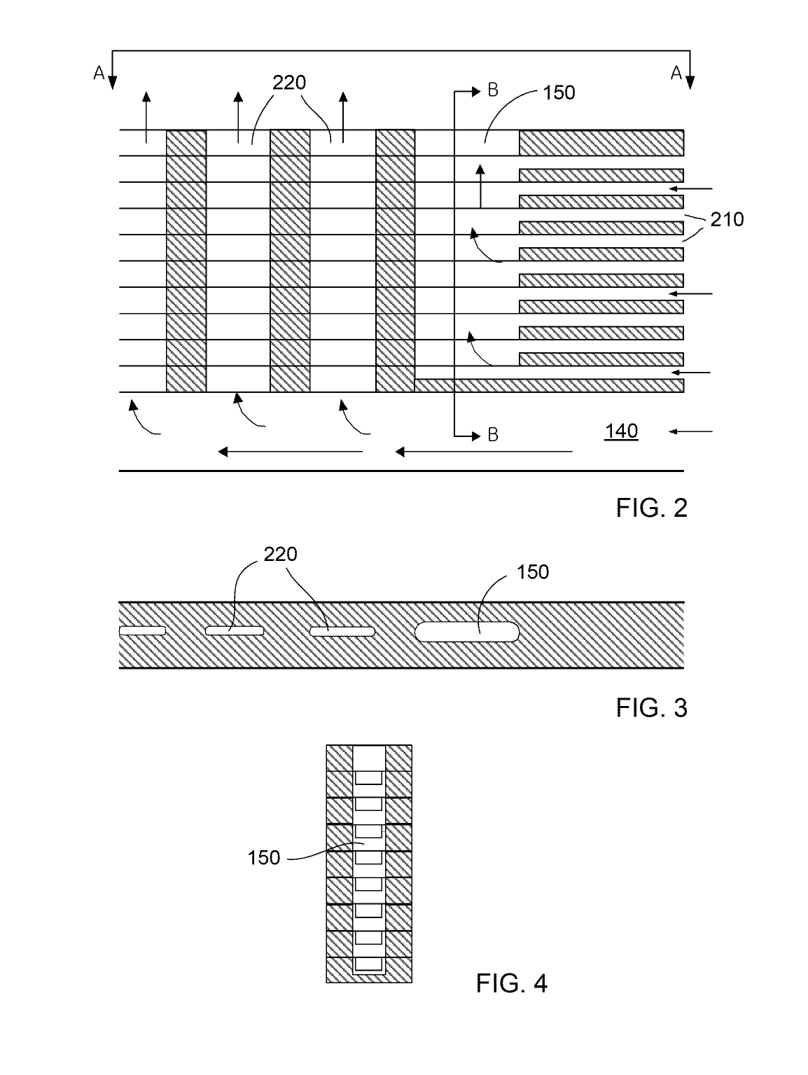

FIG. 2 shows one known system for exhausting end turn cooling grooves in the rotor of a dynamoelectric machine. The end turn cooling grooves 210 enter from the right and exhaust to the chimney 150. Cooling gas flows (as indicated by the arrows in FIG. 2) in a generally horizontal or axial direction in cooling grooves 210, and flows in a generally vertical or radial direction in ventilation chimney 150. The holes in each turn (or conductor layer) that comprise the chimney 150 can be referred to as chimney slots. Accordingly, the chimney 150 is comprised of one or more chimney slots. Additional radially oriented ducts 220 may also be located to vent gas from subslot 140. Rotor end turns may also exhaust to two chimneys, with the upper half of the grooves 210 connecting to a first chimney, and the lower grooves connecting to a second chimney.

FIG. 3 illustrates a top view along section line A-A of FIG. 2, and shows the relative size of the chimney 150 compared to the radial ducts 220. The radial cross-sectional area of chimney 150 is larger than the cross-sectional area of ducts 210 or 220. FIG. 4 illustrates a view along section line B-B of FIG. 2, and shows a cross section of the termination of the end turn cooling grooves 210 in chimney 150. It can be seen that the interior walls of chimney 150 are smooth.

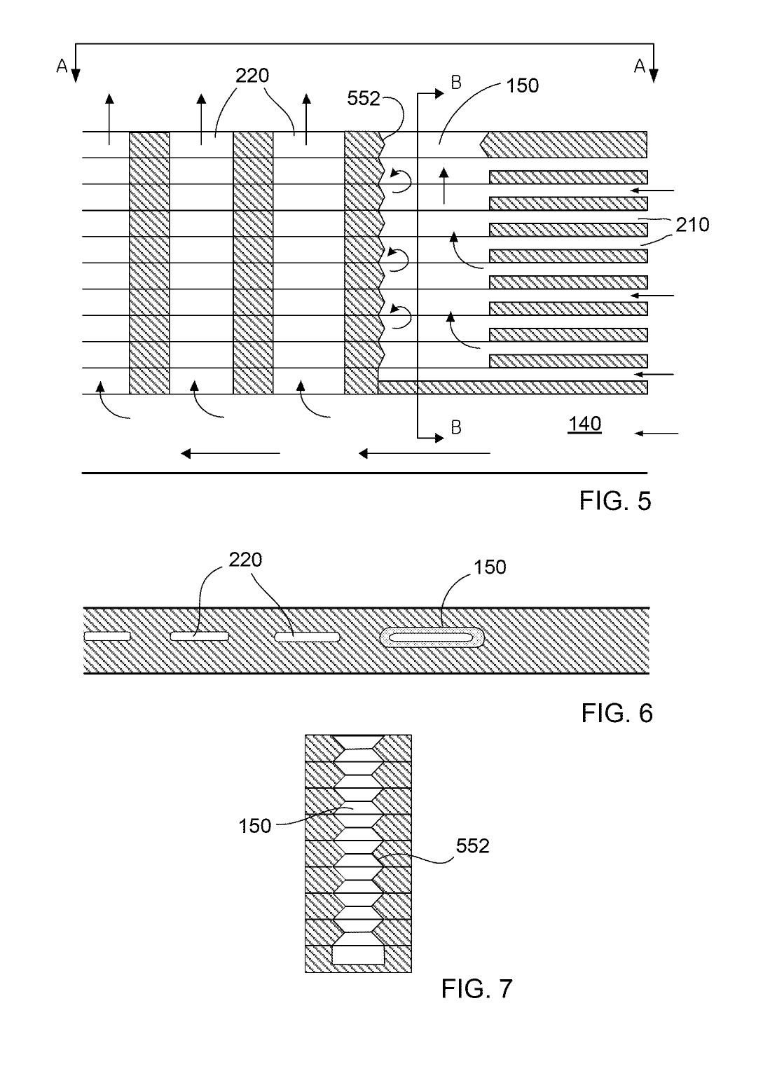

FIG. 5 illustrates one embodiment of the present invention that improves the heat transfer performance of the ventilation chimney 150. The interior walls of chimney 150 can be roughened or turbulated. In this embodiment the walls can have triangular or V-shaped projections 552 which extend out into the flow of the cooling gas. These projections 552 turbulate the gas flow and create more interactions between the surface area of the chimney 150 and the cooling gas. The result is that the warmer cooling gas in chimney 150 cools the surrounding copper windings more effectively by the increase in heat transfer area. In additional embodiments of the present invention, the projections 552 could be placed on all or a portion of the chimney 150. In some embodiments, the projections 552 could also be one or combinations of V-shaped, V-shaped with rounded corners, triangular, triangular with rounded corners, trapezoidal, trapezoidal with rounded corners, spherical, quadrilateral, and quadrilateral with rounded corners in cross-section. The projections 552 could also be formed by dimpled, irregular, scalloped, or wavy shapes.

FIG. 6 illustrates a top view along section line A-A of FIG. 5, and shows the relative size of the chimney 150 compared to the radial ducts 220. FIG. 7 illustrates a view along section line B-B of FIG. 5, and shows a cross section of the termination of the end turn cooling grooves 210 in chimney 150. It can be seen that the interior walls of chimney 150 have multiple projections which increase the heat transfer area and turbulate the flow of the cooling gas.

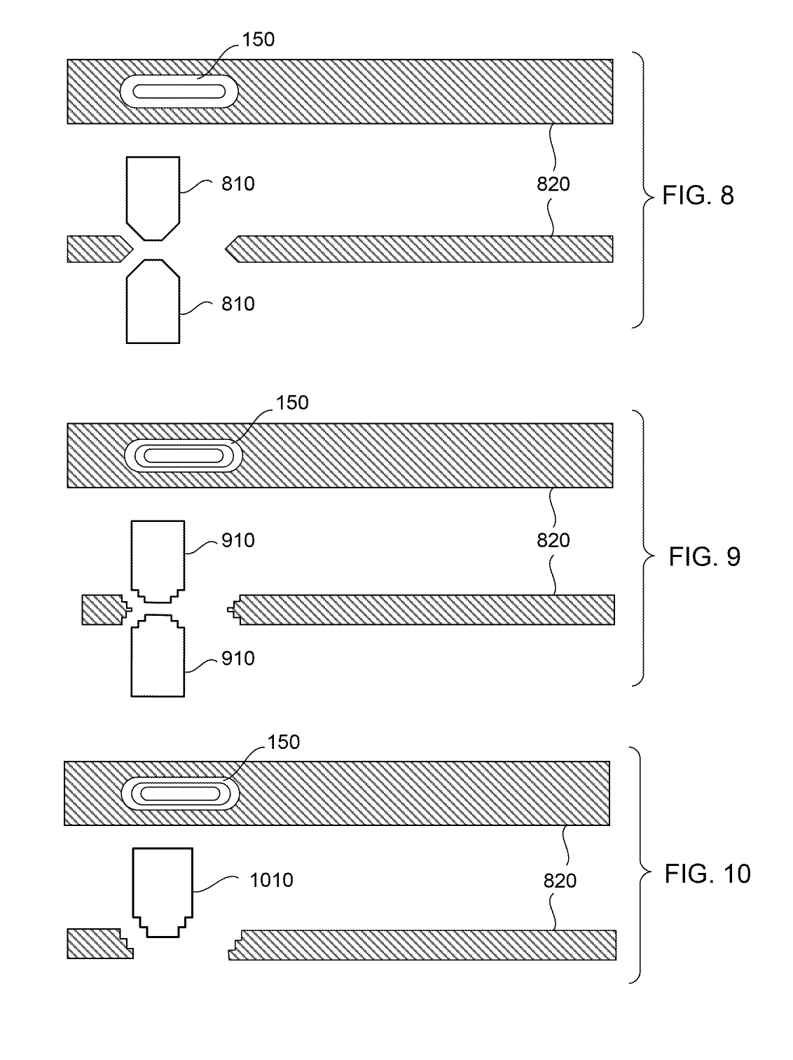

FIGS. 8, 9 and 10 illustrate various methods for obtaining a roughened surface for chimney 150. To obtain a chimney having an interior surface having projections and/or depressions the individual copper windings can be milled, coined or punched so that the edges of the chimney are roughened or have specific contours. FIG. 8 illustrates one embodiment of a milling operation that can be used to obtain a triangular profile on the chimney slot in a copper conductor 820. The milling tool 810 can have a surface profile that is designed to taper the opening (which forms part of chimney 150) in the copper conductor 820. FIG. 9 illustrates one embodiment of a milling operation that can be used to obtain a multiple stepped profile on the chimney slot in a copper conductor 820. The milling tool 910 can have a surface profile that is designed to form steps in the opening (which forms part of chimney 150) in the copper conductor 820. FIG. 10 illustrates another embodiment of a milling operation that can be used to obtain a stepped profile on the chimney slot in a copper conductor 820. The milling tool 1010 can have a surface profile that is designed to form steps in one side of the opening (which forms part of chimney 150) in the copper conductor 820.

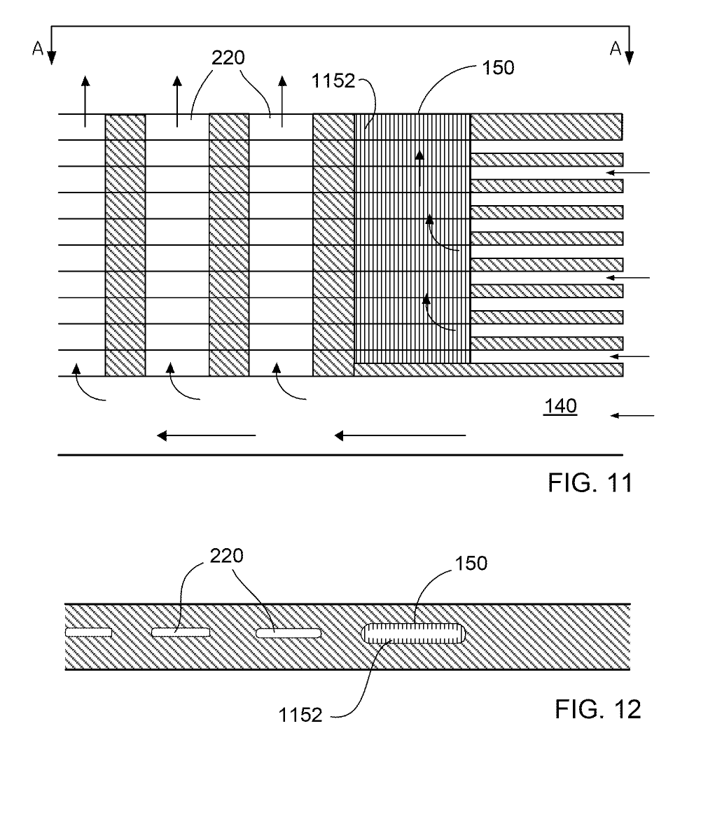

FIG. 11 illustrates another embodiment of the present invention having the inner surface of chimney 150 serrated. The serrations 1152 are shown extending in the radial or vertical direction, however, the serrations could be oriented in the axial, radial, or axial-radial directions. The axial-radial direction can be defined as any angle between the axial axis (e.g., the horizontal direction in FIG. 1) and radial axis (e.g., the vertical direction in FIG. 1) of the rotor 100. The serrations could also be formed into a spiral configuration as well. The radial serrations 1152 can be formed in each conductor layer comprising the winding, or in a portion of the conductor layers. The serrations 1152 could also be one or combinations of V-shaped, V-shaped with rounded corners, triangular, triangular with rounded corners, trapezoidal, trapezoidal with rounded corners, quadrilateral, and quadrilateral with rounded corners in cross-section. FIG. 12 illustrates a top view along section line A-A of FIG. 11, and shows the serrations 1152 projecting into chimney 150. The serrations 1152 increase the thermal transfer area of the chimney 150 and improve the cooling effectiveness of the gas passing through and up the chimney.

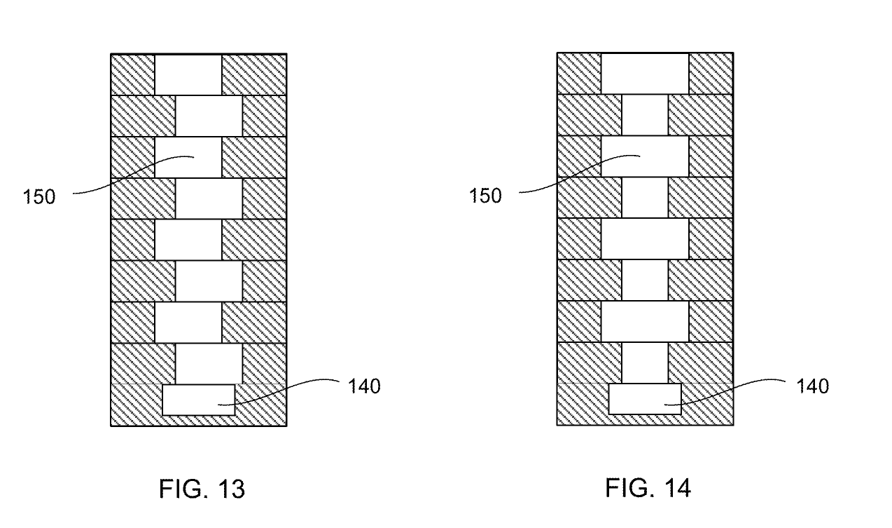

FIG. 13 illustrates another embodiment where chimney 150 is constructed of chimney slots that are circumferentially offset. Each conductor layer can have a hole or chimney slot that is circumferentially offset with respect to an adjacent or other conductor layers, so that the chimney is formed with an arduous flow path. The offset flow path disturbs the flow and creates turbulence as it forces the gas to jog back and forth. One result is increased interaction between the cooling gas and the surface of chimney 150. The offset pattern also increases the surface area of chimney 150, which helps to improve the thermal transfer performance. The chimney slots can be circumferentially offset by various amounts or in groups. For example, in some embodiments a first group of two or more adjacent conductor layers could have the chimney slots located in the same circumferential position and a second group of adjacent chimney slots could have their chimney slots located in a different circumferential position. In other embodiments, some or all of the chimney slots can be located in multiple or different circumferential positions. The chimney slots may also be configured to vary their position in the circumferential and axial directions.

FIG. 14 illustrates another embodiment where chimney 150 is constructed of alternating sized chimney slots. Each conductor layer can have a hole or chimney slot that is of a different size with respect to the adjacent conductor layers. The variable size flow path disturbs the flow and creates turbulence and increases interaction between the cooling gas and the surface of chimney 150. The surface area of chimney 150 is also increased, which helps to improve the thermal transfer performance. In some embodiments, the chimney slots may comprise two or more different sizes. In other embodiments, the chimney slots may comprise groups of adjacent chimney slots having the same or different sizes.

Any of the previously described chimney configurations can be combined with each other or modified to suit the specific application. All of the above embodiments can be used with radial flow and gap pickup methods of cooling the rotor body, and can be used in single, twin or multiple chimney configurations. In some embodiments, alternating sizes or positions were shown, however, multiple sizes (e.g., more than two) and/or multiple positions (e.g. more than two) can be used to obtain increased heat transfer performance. The methods, systems and devices described herein can be used in dynamoelectric machines that are cooled with air, hydrogen gas or any other suitable cooling medium. The ventilation chimneys are typically located at the drive and non-drive ends of the rotor body, and the embodiments herein described could be applied to either or both of the drive and non-drive ends of the rotor body.

While the invention has been described in terms of various specific embodiments, those skilled in the art will recognize that the invention can be practiced with modification within the spirit and scope of the claims.

What is claimed is:

1. A cooling gas ventilation chimney for an end region of a dynamoelectric machine having a rotor, a plurality of radial slots provided in said rotor, and a plurality of coils respectively seated in said plurality of radial slots, said plurality of coils comprising a plurality of radially stacked turns, said ventilation chimney comprising:
one or more chimney slots defined in at least a portion of said radially stacked turns, said one or more chimney slots extending in a substantially radial direction to said rotor, and
wherein at least a portion of a surface of said one or more chimney slots is turbulated so as to have a roughened surface profile for enhanced heat transfer.

2. The cooling gas ventilation chimney according to claim 1, wherein said one or more chimney slots comprise one or more projections.

3. The cooling gas ventilation chimney according to claim 2, wherein said projections are generally one or combinations of:
V-shaped, V-shaped with rounded corners, triangular, triangular with rounded corners, trapezoidal, trapezoidal with rounded corners, quadrilateral, and quadrilateral with rounded corners in cross-section.

4. The cooling gas ventilation chimney according to claim 1, wherein the roughened surface profile of said ventilation chimney comprises a plurality of ribs or serrations.

5. The cooling gas ventilation chimney according to claim 4, wherein said plurality of ribs are generally, at least one or combinations of, V-shaped, V-shaped with rounded corners, triangular, triangular with rounded corners, trapezoidal, trapezoidal with rounded corners, quadrilateral, and quadrilateral with rounded corners in cross-section.

6. The cooling gas ventilation chimney according to claim 5, wherein at least a portion of said plurality of ribs are oriented substantially radially to said rotor.

7. The cooling gas ventilation chimney according to claim 5, wherein at least a portion of said plurality of ribs are oriented in a direction between an axial axis and radial axis of said rotor.

8. The cooling gas ventilation chimney according to claim 1, wherein said roughened surface profile comprises one or more surface indentations.

9. The cooling gas ventilation chimney according to claim 8, wherein said surface indentations are substantially hemispherically shaped.

10. The cooling gas ventilation chimney according to claim 1, wherein said roughened surface profile comprises a multiple stepped surface.

11. The cooling gas ventilation chimney according to claim 1, wherein said roughened surface profile is obtained by offsetting the position of at least a portion of said chimney slots in a substantially axial direction, and
wherein at least a portion of said ventilation chimney is comprised of a substantially non-linear path.

12. The cooling gas ventilation chimney according to claim 1, wherein said roughened surface profile is obtained by offsetting the position of at least a portion of said chimney slots in a substantially circumferential direction, and
wherein said ventilation chimney is comprised of a substantially non-linear path.

13. The cooling gas ventilation chimney according to claim 1, wherein said roughened surface profile is obtained by offsetting the position of at least a portion of said chimney slots in a substantially circumferential direction and a substantially axial direction, and
wherein said ventilation chimney is comprised of a substantially non-linear path.

14. The cooling gas ventilation chimney according to claim 1, wherein said roughened surface profile is obtained by an alternating series of larger and smaller openings in successive coils.

15. The cooling gas ventilation chimney according to claim 1, wherein said roughened surface profile is obtained by differently sized openings in at least a portion of said coils.

16. The cooling gas ventilation chimney according to claim 1, wherein said roughened surface profile of said ventilation chimney is obtained by milling projections or indentations in one or more of said chimney slots.

17. The cooling gas ventilation chimney according to claim 1, wherein said roughened surface profile of said ventilation chimney is obtained by coining projections or indentations in one or more of said chimney slots.

18. The cooling gas ventilation chimney according to claim 1, wherein said roughened surface profile of said ventilation chimney is obtained by punching projections or indentations in one or more of said chimney slots.
